(19) United States
(12) Patent Application Publication
(10) Pub. No.: US 2005/0279785 A1
(43) Pub. Date: Dec. 22, 2005

(54) Child carrier

(75) Inventors: Brenda Liistro, Westport, CT (US); Jennifer Reed, Westport, CT (US); Marc Freedgood, Sherborn, MA (US); John Rousso, Trumbull, CT (US); Linda Doyle, Mansfield, MA (US)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Playtex Products, Inc.

(21) Appl. No.: 11/043,833

(22) Filed: Jan. 26, 2005

Related U.S. Application Data
(60) Provisional application No. 60/539,667, filed on Jan. 27, 2004.
(60) Provisional application No. 60/540,131, filed on Jan. 29, 2004.
(60) Provisional application No. 60/543,045, filed on Feb. 9, 2004.

(51) Int. Cl. A61G 1/00

(52) U.S. Cl. 224/160

(57) ABSTRACT

A child carrier is provided. The child carrier has independently adjustable shoulder and waist straps that allow interchangeable use on either hip of the user. The child carrier has a removable storage container that is selectively connectable thereto.

### CROSS-REFERENCE TO RELATED APPLICATIONS

The present application is claiming priority of co-pending U.S. Provisional Application No. 60/539,667, filed on Jan. 27, 2004, co-pending U.S. Provisional Application No. 60/540,131, filed on Jan. 29, 2004, and co-pending U.S. Provisional Application No. 60/543,045, filed on Feb. 9, 2004, the contents of which are herein incorporated by reference.

### BACKGROUND OF THE INVENTION

1. Field of the Invention

The present invention relates to child carriers. More particularly, the present invention relates to shoulder and/or hip carriers for children.

2. Description of Related Art

Carrying devices for children are known. Such devices have shoulder straps and typically carry the child up against the body of the user, with the child carrier providing support from under and behind the child.

While providing support for an infant or child, these contemporary carriers suffer from the drawback of being uncomfortable to the user and/or the child. Additionally, such devices also suffer from a lack of adjustability in carrying, as well as a lack of storage.

Accordingly, there is a need for a child carrier that reduces or eliminates these drawbacks. There is a further need for a child carrier that provides comfort to the wearer and/or the child, adjustability in carrying, and adequate storage.

### SUMMARY OF THE INVENTION

It is an object of the present invention to provide a child carrier that is interchangeably usable with either shoulder and/or either hip of the user.

It is another object of the present invention to provide such a child carrier with components that are selectively connectable and independently adjustable.

It is yet another object of the present invention to provide such a child carrier that provides additional storage.

It is yet a further object of the present invention to provide such a child carrier that improves comfort to the user and/or the child.

It is still another object of the present invention to provide such a child carrier that facilitates holding of the child.

It is still a further object of the present invention to provide such a child carrier that improves protection to the user and/or child.

These and other objects and advantages of the present invention are provided by a child carrier having independently adjustable shoulder straps and/or waist straps so that a user can support the child over either shoulder and/or either hip in a variety of positions.

In another aspect, a child carrier is provided that has a holding portion made of layers of different material so that the desired properties of each of those layers can be used for the child carrier, such as, for example, flexibility, strength, comfort, and leak-resistance.

In another aspect, a child carrier is provided that has a removable storage container selectively connectable to a portion of the child carrier, such as, for example, the waist strap. The storage container can be a flexible pouch.

In another aspect, a child carrier is provided that has a hood to protect the child, such as, for example, against cold, sun, rain and/or wind. The hood can be stored in a closable storage compartment when not in use. The hood may be adjustable. The hood can also be removably connected to the child carrier.

Other and further objects, advantages and features of the present invention will be understood by reference to the following:

### BRIEF DESCRIPTION OF THE DRAWINGS

FIG. 1 is a front plan view of the child carrier of the present invention;

FIG. 2 is a back plan view of the child carrier of FIG. 1;

FIG. 3 is a cross-sectional view of the shoulder pad of FIG. 1 taken along line 3-3 of FIG. 2;

FIG. 4 is a plan view of the child carrier of FIG. 1 in use over the right shoulder and left hip;

FIG. 5 is a plan view of the carrier of FIG. 1 in a stored position;

FIG. 6 is a plan view of an alternative embodiment of the shoulder pad of FIG. 1;

FIG. 7 is a front plan view of an alternative embodiment of the child carrier of the present invention;

FIG. 8 is a back plan view of the child carrier of FIG. 7;

FIG. 9 is a front plan view of another alternative embodiment of the child carrier of the present invention;

FIG. 10 is a side view of the child carrier of FIG. 9;

FIG. 11 is a front plan view of the child carrier of FIG. 9 with the hood extended;

FIG. 12 is a side view of the child carrier of FIG. 9 with the hood extended; and

FIG. 13 is a perspective view of the child carrier of FIG. 9 with the hood extended and in use.

### DETAILED DESCRIPTION OF THE INVENTION

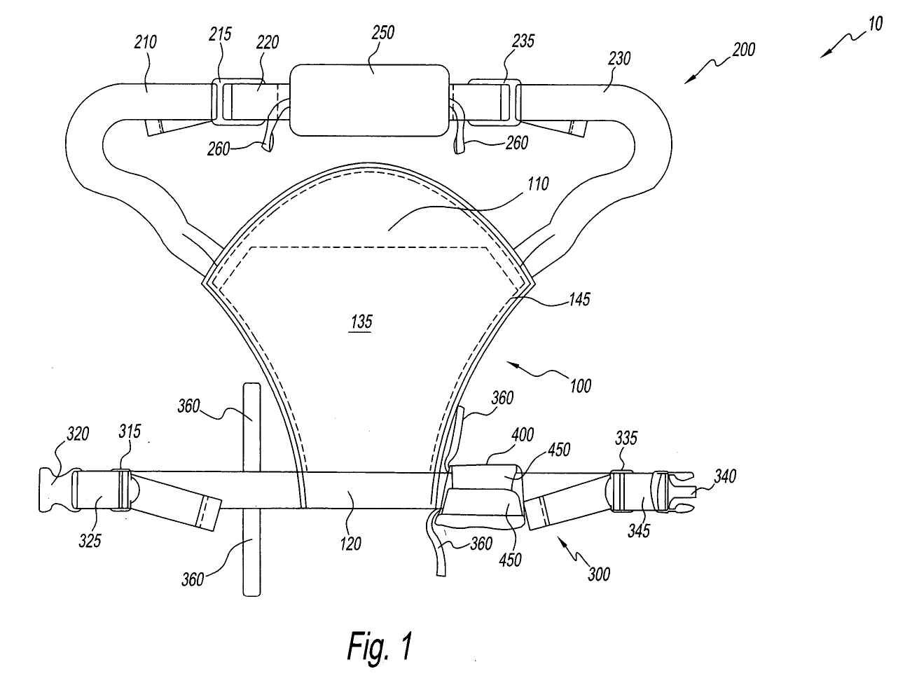

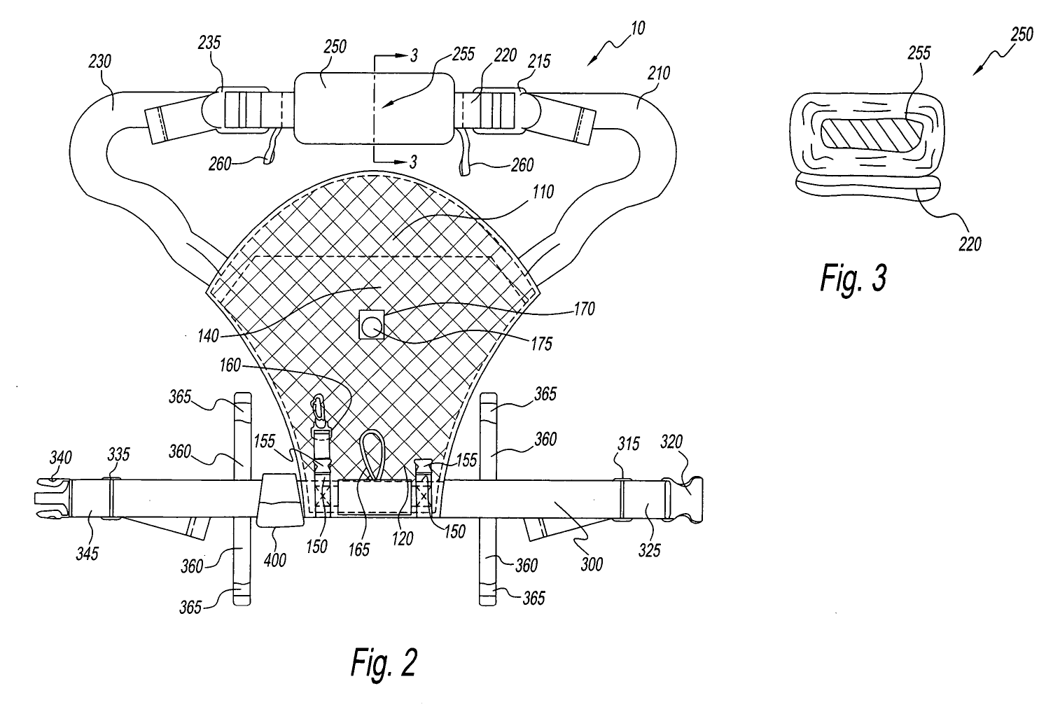

Referring to the figures, and in particular FIGS. 1 and 2, the child carrier of the present invention is generally referred to by reference numeral 10. The child carrier 10 has a holding or seat portion 100, a shoulder strap 200 and a waist strap 300. As will be described herein, the shoulder and waist straps 200, 300 are independently adjustable with respect to holding portion 100 to allow a user to position the child carrier 10 on either hip, and also to provide flexibility and comfort in positioning the holding portion 100 with respect to the user and also with respect to the child.

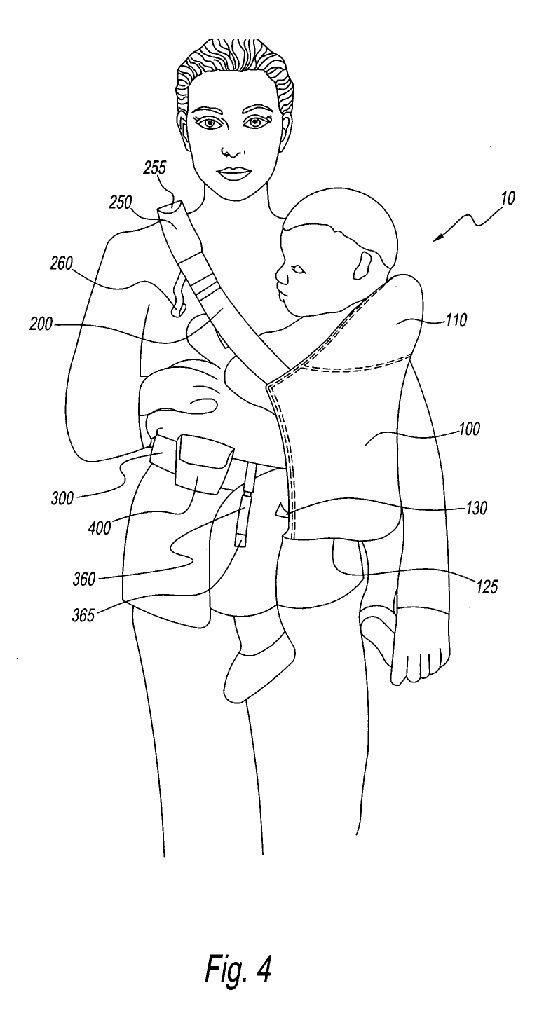

Referring to FIGS. 1 through 4, holding portion 100 has an upper end 110 and a lower end 120. Upper end 110 preferably has an upwardly arcuate shape, which provides additional support for the child by extending up to the infant's neck and head. Lower end 120 preferably has a flat shape with a width that is narrower than the rest of the holding portion 100. The narrow width of lower end 120 allows it to be folded over upon itself, to form a seat 125 and leg openings 130 for the child (as shown in FIG. 4).

Holding portion 100 is preferably formed from a number of layers of fabric material. The layers of fabric material may be different materials having different desired properties, such as, for example, strength, flexibility, or being pleasantly tactile. Holding portion 100 has an inner face 135 that is made from a material having more than one, but preferably all, of the following properties: strong, durable, flexible and leak-resistant material.

Holding portion 100 has an outer face 140 that is preferably made from a soft material, such as, for example, Ultrasuede®, fleece or twill. Alternatively, the inner face 135 can be made from the soft material, such as, for example, Ultrasuede®, fleece or twill, and the outer face 140 can be made from the strong, durable, flexible and leak-resistant material. Additionally, other combinations of materials having the same or different tactile properties can also be used for either or both of the inner and outer faces 135, 140 of holding portion 100. The different layers of fabric may be connected to each other along the outer periphery of holding portion 100 by stitching 145, which further adds to the flexibility of the holding portion. However, the present invention contemplates the use of other structures and methods of connecting the layers of fabric together to form holding portion 100, such as, for example, adhesive, as well as connecting the layers in areas in addition to, or other than, the periphery, such as, for example, cross-stitching over a central area of the holding portion.

Holding portion 100 preferably has first storage straps 150 connected to the lower end 120 of the holding portion. First storage straps 150 have connectors 155 at a distal end of the strap that can selectively connect to a first coupling strap 160. The first coupling strap 160 can be used for holding keys and other objects. The first coupling strap 160 can be connected to either (or both with a second coupling strap) of the first storage straps 150 depending on which hip/shoulder the child carrier 10 is being used with. Lower end 120 of holding portion 100 preferably has a loop 165. More preferably, loop 165 is flexible, such as, for example, a bungee cord or loop.

The outer face 140 may also have a second storage strap or button strap 170. Button strap 170 has a button 175 connected thereto for additional storage of an item that can be connected to the child carrier 10 via a button connection. Additionally, when the baby carrier 10 is not in use, flexible loop 165 can be used to roll the holding portion 100 up on the user's waist, by engaging the flexible loop with button 175. This eliminates the need to remove the child carrier 10, which might be awkward and/or uncomfortable if left fully extended without the baby being carried.

Shoulder strap 200 has first, second and third straps 210, 220 and 230. First and third straps 210, 230 are of the same length and width, and are preferably permanently connected to the upper end 120 of the holding portion 100, such as, for example, by stitching. The distal ends of the first and third straps 210, 230 have adjusters 215, 235 connected thereto. In the preferred embodiment of child carrier 10, each adjuster 215, 235 is permanently connected to second strap 220, and adjustably connected to the corresponding first or third strap 210, 230.

Adjusters 215, 235 are preferably locking sliders with finger tabs that provide for quick and easy adjustment of the length of the first and third straps 210, 230. However, alternative connection structures and methods can also be used. The adjustable connections between the first, second and third straps 210, 220, 230, allow a user to select the desired overall length of the shoulder strap 200. This adjustability and flexibility allows a user to interchangeably use the child carrier 10 over either shoulder or hip, as desired. This is especially advantageous to relieve discomfort from prolonged use over only one of the user's shoulders.

Shoulder strap 200 has a shoulder pad 250. Preferably, shoulder pad 250 is permanently connected to second strap 220, such as, for example, by stitching, to prevent sliding of the pad off of the user's shoulder. Shoulder pad 250 has soft, flexible, resilient padding, such as, for example, foam, which provides comfort to the user's shoulder against the weight of the child.

Shoulder pad 250 preferably has a middle portion 255 with a reduced size, such as, for example, a reduced thickness, width or height. The reduced size of middle portion 255 facilitates engagement of the user's shoulder with the shoulder pad 250, and further minimizes slippage of the shoulder pad off of the user's shoulder. Alternatively, the padding of shoulder pad 250 may be contoured in other ways, shapes or forms, such as, for example, a groove traversing the lower surface of the padding along middle portion 255.

The shoulder pad 250 preferably has padding contained in a flexible outer material, such as, for example, a fabric. In the preferred embodiment, the shoulder pad is surrounded by Ultrasuede® to further provide comfort to the user's shoulder.

Referring to FIG. 6, in an alternative embodiment of the shoulder pad generally represented by reference numeral 1250, the padding has a curved shape to provide additional comfort to the user's shoulder. The curved shape of shoulder pad 1250 also further prevents any slippage of the pad off of the shoulder.

Referring back to FIGS. 1 through 4, shoulder pad 250 has at least one, and preferably a pair of, third storage straps 260. More preferably, third storage straps 260 are disposed on opposing sides of the shoulder pad 250. However, the third storage straps 260 can be connected to other areas of the shoulder pad 250, and can also be connected to other areas of the shoulder strap 200 or child carrier 10, such as, for example, to first strap 210 or third strap 230.

Third storage straps 260 is preferably disposed in proximity to the child's hands and/or face to hold toys and other such objects that are usable by the child. In the preferred embodiment of child carrier 10, third storage straps 260 are substantially rectangular straps that have a fastener at a distal end, such as, for example, Velcro®, so that the strap can be folded over upon itself to form a loop. The loop-type of fastener of third storage strap 260 maintains safety for the child, as compared to other types of fasteners. However, alternative structures and methods can also be used for third storage straps 260 to provide for the holding of the child's toys or other objects.

Waist strap 300 preferably is a single strap that is connected along lower end 120 of holding portion 100. More preferably, waist strap 300 is stitched to the holding portion 100, but alternative structures and methods can also be used to connect the waist strap and the holding portion, such as, for example, adhesive. Additionally, the present invention uses a single strap that is permanently connected across the lower portion 120 of holding portion 100 to improve strength and facilitate use. Alternatively, the waist strap 300 can be a number of straps and can also be selectively connected to the holding portion 100 through connectors and the like.

The distal ends of the waist strap 300 each have adjusters 315, 335 connected thereto. In the preferred embodiment of child carrier 10, each adjuster 315, 335 is permanently connected to corresponding waist connectors 320, 340, respectively, (with their corresponding strap portions 325, 345, respectively), and adjustably connected to the distal ends of waist strap 300.

Adjusters 315, 335 are preferably locking sliders with finger tabs that provide for quick and easy adjustment of the length of the waist strap 300, as well as allowing independent adjustment of the length of each distal end of the waist strap. However, alternative connection structures and methods can also be used. Waist connectors 320, 340 are preferably male and female squeeze-actuated connectors that allow for quick and easy connection of the waist strap 300. However, alternative connection structures and methods can also be used for waist strap 300.

Referring to FIGS. 1 through 5, in the preferred embodiment, child carrier 10 can be closed and/or rolled/folded through use of bungee loop 165 and button 175. However, alternative closing structures and methods can be used, such as, for example, closure straps 360 on waist strap 300. Child carrier 10 shows both methods of closing the device, i.e., loop and button 165, as well as closure straps 360. However, only one of the closing devices would be necessary on the child carrier 10, although both could be included.

Preferably, there is at least one, and preferably two, pairs of closure straps 360. More preferably, each pair of closure straps 360 is disposed on opposing sides of the waist strap 300 with the holding portion 100 positioned therebetween. The closure straps 360 preferably extend substantially perpendicular to the waist strap 300. However, the closure straps 360 can be connected to other areas of the waist strap 300, and can also be connected to other areas of the child carrier 10, such as, for example, to first strap 210 or third strap 230.

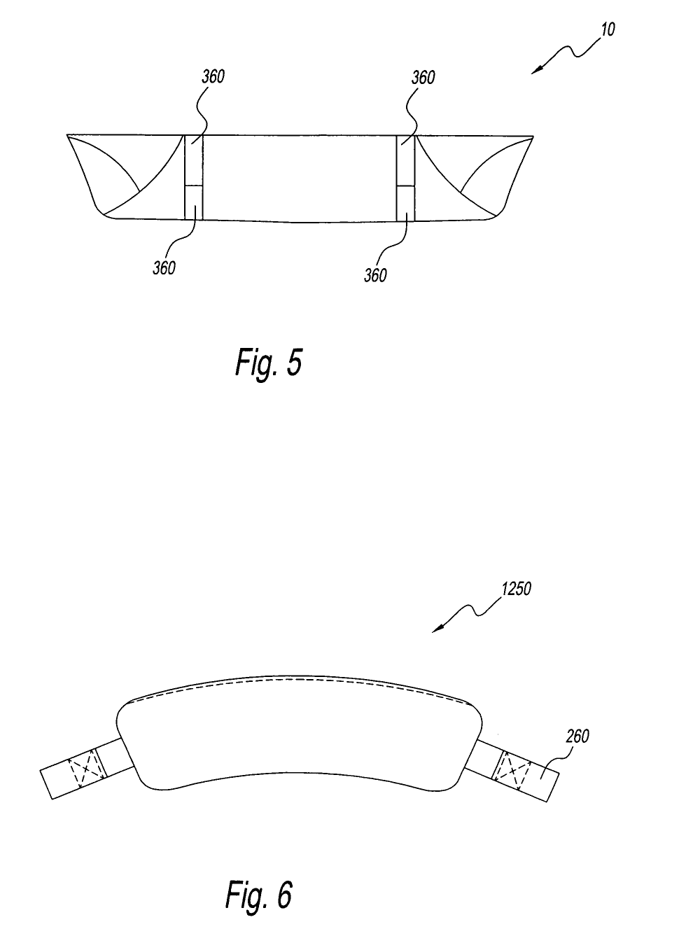

Preferably, closure straps 360 are substantially rectangular straps that have a fastener 365 at a distal end, such as, for example, Velcro®, so that each pair of closure straps can be selectively connected to each other and wrapped around the child carrier after the child carrier has been rolled up for storage, as shown in FIG. 5. However, alternative structures and methods can also be used for closure straps 360 to provide for storage of the child carrier 10.

Child carrier 10 preferably has a storage container 400 removably securable thereto. In the preferred embodiment, storage container 400 is a flexible, soft pouch that can be selectively connected to waist strap 300. Alternative materials, shapes and sizes of the storage container 400 can also be used for removable connection with the child carrier 10. Preferably, storage pouch 400 has a back surface with a connector secured thereto, such as, for example, flaps 450 with a fastener, such as, for example, Velcro®, so that the pouch can be quickly and easily connected to, and around, a portion of the waist strap 300. However, the present invention contemplates the use of other structures and methods for removably connecting the storage pouch 400 to the waist strap 300, as well as alternative removable positionings of the storage pouch along the child carrier 10.

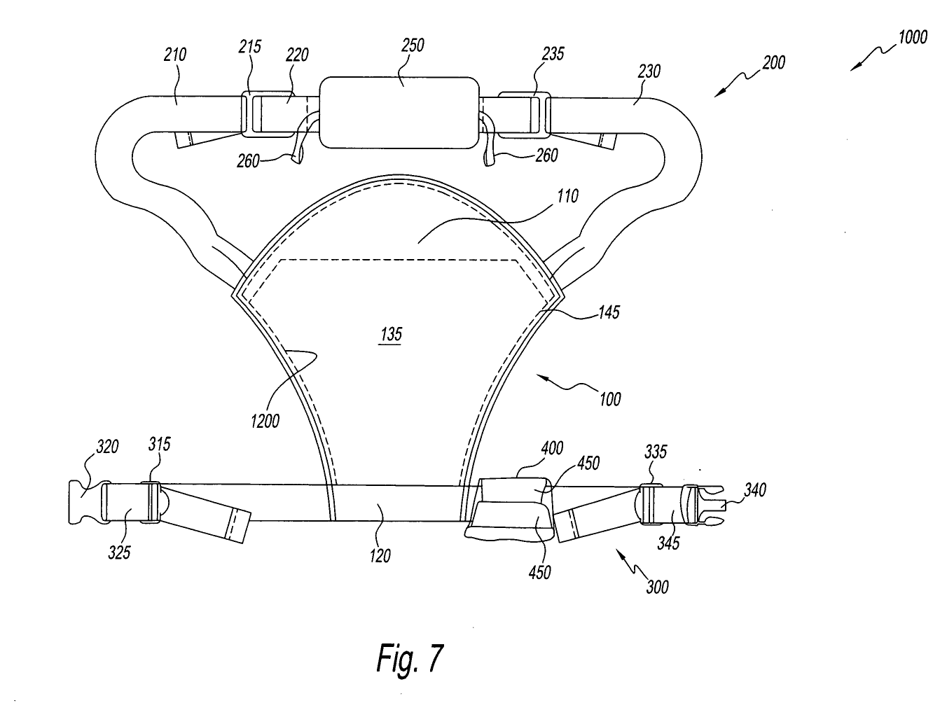

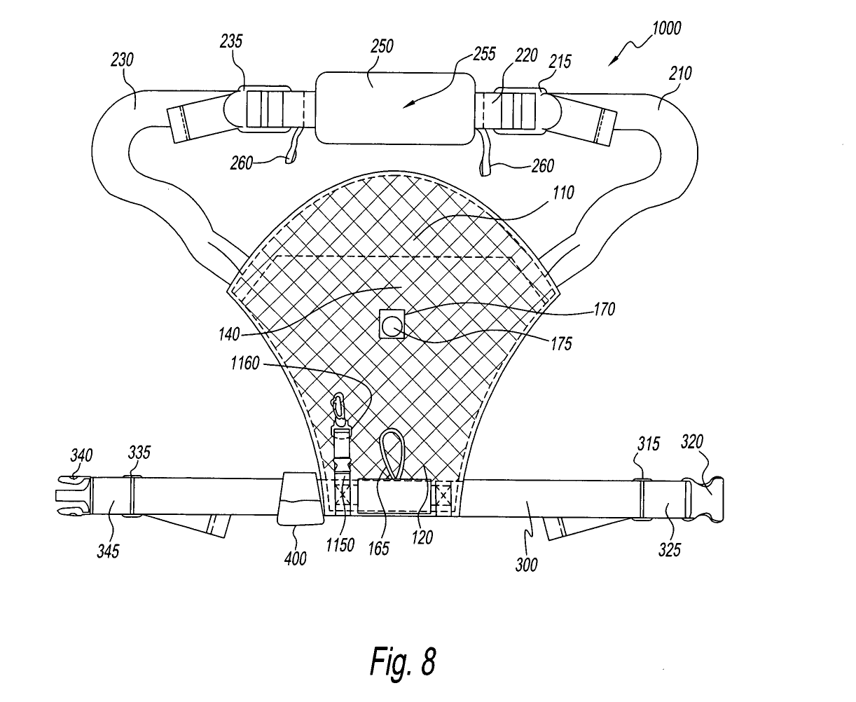

Referring to FIGS. 7 and 8, an alternative embodiment of the child carrier of the present invention is shown and generally referred to by reference numeral 1000. Child carrier 1000 has many features that are the same, or similar to, the features of child carrier 10 of FIGS. 1 through 6, and which are similarly numbered and described-above, such as, for example, storage pouch 400.

Child carrier 1000 has the bungee loop 165 that is selectively connectable to button 175, in order to store the carrier in a rolled-up position. Thus, the alternative embodiment of child carrier 1000 may not include closure straps 360 along waist strap 300.

The child carrier 1000 has a storage strap 1150 that is preferably permanently connected to the lower end 120 of holding portion 100, such as, for example, by stitching. The storage strap 1150 has a distal end with a clamping mechanism 1160. Preferably, clamping mechanism 1160 is permanently connected to storage strap 1150, such as, for example, by stitching. Clamping mechanism 1160 can be a spring-loaded mechanism that allows for quick and easy connection with the item that is to be stored. Preferably, clamping mechanism 1160 is a nylon spring-loaded clamp.

Child carrier 1000 has piping 1200 formed along the perimeter of the holding portion 100. Preferably, piping 1200 extends along the entire perimeter of holding portion 100, except for the lower end 120.

Shoulder pad 250 preferably has denser foam disposed in the area of middle portion 255 (as compared to the density of foam used in the rest of the shoulder pad). The denser foam provides additional support and comfort for the user, and his or her shoulder, against the weight of the child and child carrier 1000.

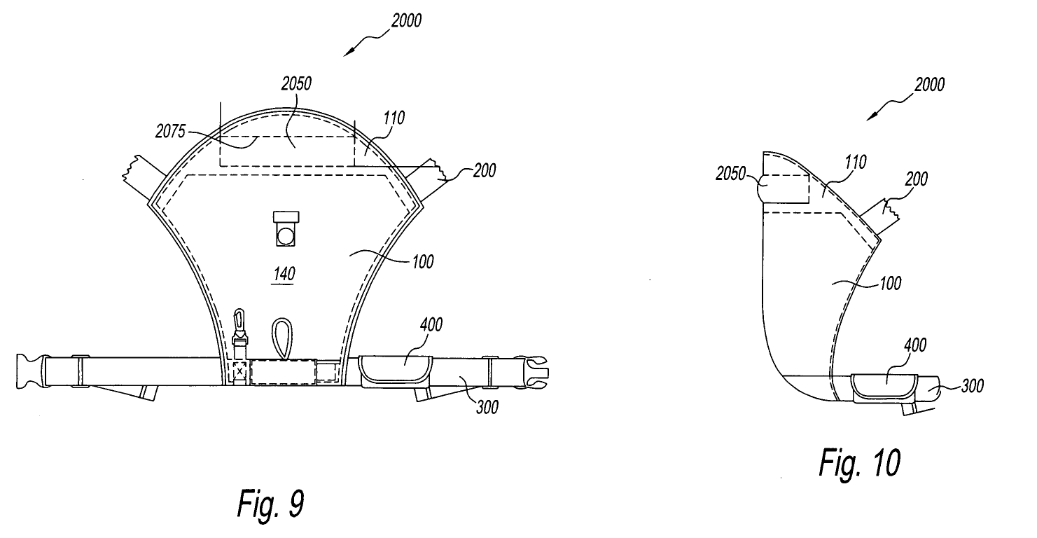

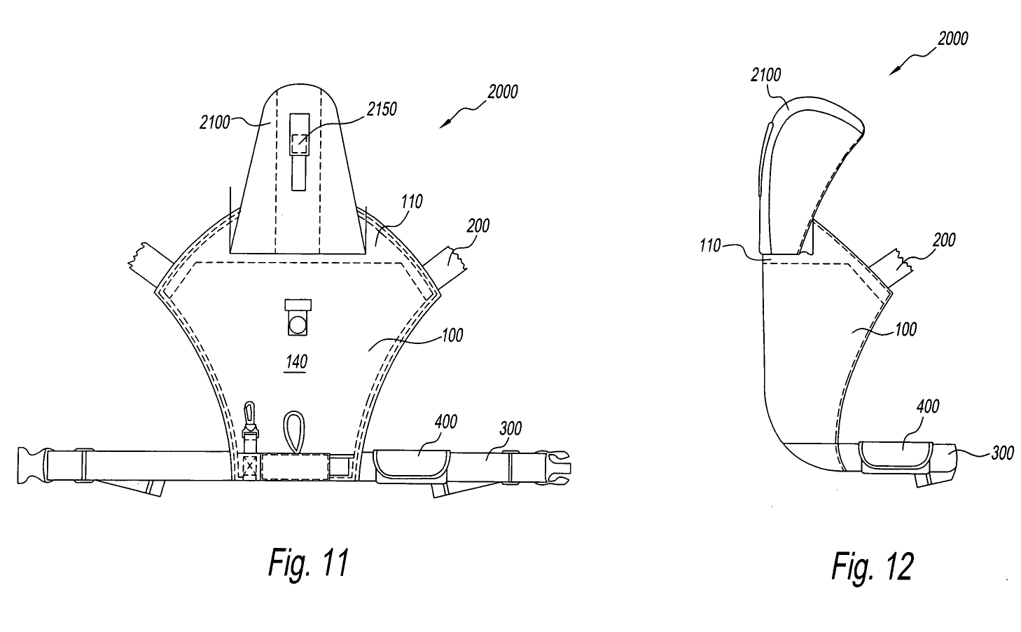

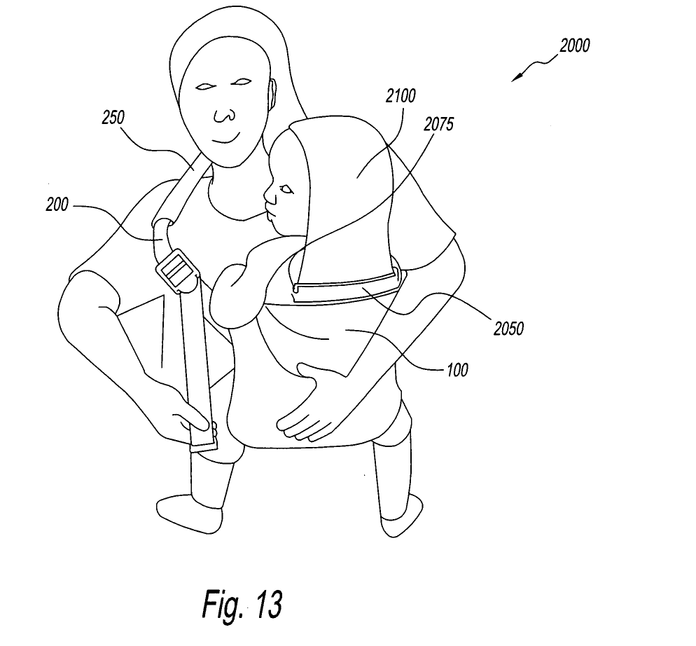

Referring to FIGS. 9 through 13, an alternative embodiment of the child carrier of the present invention is shown and generally referred to by reference numeral 2000. Child carrier 2000 has many features that are the same, or similar to, the features of child carrier 10 of FIGS. 1 through 6 and/or child carrier 1000 of FIGS. 7 and 8, and which are similarly numbered and described-above, such as, for example, storage pouch 400. Individual features of any of these three embodiments could be used with the other embodiments, as well as with other child carriers that are contemplated by the present invention.

Child carrier 2000 has a hood compartment 2050 with a hood 2100 stored therein. Preferably, hood compartment 2050 is disposed along the upper end 110 of holding portion 100. More preferably, hood compartment 2050 is disposed along the outer face 140 of the holding portion 100. Hood 2100 is connected to holding portion 100, such as, for example, by stitching, and is preferably connected inside of the hood compartment 2050 to facilitate removal and storage of the hood. Alternatively, hood 2100 can be removably connected to child carrier 2000, such as, for example, by Velcro®, with or without the hood compartment 2050.

Hood compartment 2050 has a closure member 2075 that allows the hood 2100 to be securely stored within the compartment, such as, for example, a zipper or a flap with Velcro®. Hood 2100 preferably has an adjuster 2150 that allows for adjustment of the shape, height, and width of the hood. Adjuster 2150 can be any known adjustment mechanism or method, such as, for example, a perimeter string. Hood 2100 is ergonomically shaped to comfortably and efficiently fit and protect the infant or child's head, and can include other features, such as, for example, a visor. Hood 2100 provides protection to the head of the child. The hood 2100 is also easily and quickly stored in hood compartment 2050.

Hood 2100 is made from a material that provides protection against the elements including cold, wind, sun and/or rain. Hood 2100 can also be made from a number of layers of material that are connected to each other, such as, for example, by stitching, by adhesive, or by a combination of both. The layers of material of hood 2100 may be different materials having different desired properties, such as, for example, thermal insulation, strength, flexibility, water-resistance, wind-resistance, sun-resistance, light-weight and/or being pleasantly tactile.

The inside of hood 2100 will be against the child's head and face, and can be made from a material that is pleasantly tactile, such as, for example, soft material. Additionally, other material and/or combinations of materials having different properties can also be used for hood 2100. Hood 2100 can also be a number of different hoods that are usable based upon the particular climate, such as, for example, cold, rain, wind, and/or sun. The number of different hoods 2100 can be removably connectable with the child carrier 2000 so that the user can select which hood will be used.

It should be noted that the terms “first”, “second”, “upper”, “lower” and the like, are used herein to modify various elements. These modifiers do not necessarily imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

1. A child carrier comprising:
a seat portion having an upper end and a lower end;
a shoulder strap connected to said upper end; and
a waist strap connected to said lower end, said shoulder strap having a first strap connected to said upper end, a second strap adjustably connected to said first strap, and a third strap adjustably connected to said second strap opposite said first strap, wherein said third strap is connected to said upper end.

2. The child carrier of claim 1, wherein said shoulder strap has at least one pair of storage straps, each of said at least one pair of storage straps having a first storage strap extending substantially perpendicular from said shoulder strap and a second storage strap extending substantially perpendicular from said shoulder strap in an opposing direction to said first storage strap, and wherein said first storage strap is removably connectable to said second storage strap.

3. The child carrier of claim 1, wherein said first strap and said third strap are permanently fixed to said upper end.

4. The child carrier of claim 1, wherein said first strap is connected to said second strap via a first adjuster, and wherein said third strap is connected to said second strap via a second adjuster.

5. The child carrier of claim 4, wherein said first adjuster and said second adjuster are locking sliders with finger tabs permanently connected to said second strap, wherein said first adjuster is adjustably connected to said first strap, and wherein said second adjuster is adjustably connected to said third strap.

6. The child carrier of claim 1, wherein said second strap has a shoulder pad.

7. The child carrier of claim 6, wherein said shoulder pad has a middle portion with a reduced size.

8. The child carrier of claim 6, wherein said shoulder pad comprises foam having a middle portion and end portions, and wherein said middle portion has a higher density than said end portions.

9. The child carrier of claim 6, wherein said shoulder pad has a curved shape.

10. The child carrier of claim 1, further comprising a hood connected to said upper end.

11. A child carrier comprising:
a seat portion having an upper end and a lower end;
a shoulder strap connected to said upper end;
a waist strap connected to said lower end; and
a storage container selectively connectable to the child carrier.

12. The child carrier of claim 11, wherein said storage container is a flexible pouch.

13. The child carrier of claim 11, wherein said storage container has a back surface with a connector.

14. The child carrier of claim 13, wherein said connector comprises a first flap and a second flap, and wherein each of said first flap and said second flap have a fastener removably connecting said first flap to said second flap around said waist strap or said shoulder strap.

15. The child carrier of claim 11, further comprising a hood connected to said upper end.

16. A child carrier comprising:
a seat portion having an upper end and a lower end;
a shoulder strap connected to said upper end;
a waist strap connected to said lower end; and
a closing structure that selectively secures the child carrier in a closed position.

17. The child carrier of claim 16, wherein said closing structure comprises a flexible loop and a button, said button being connected to said seat portion between said upper end and said lower end, said flexible loop being connected to said lower end, said flexible loop being removably connectable to said button around the child carrier in said closed position.

18. The child carrier of claim 16, wherein said closing structure comprises at least one pair of closure straps, said at least one pair of closure straps having a first closure strap extending substantially perpendicular to said waist strap and a second closure strap extending substantially perpendicular to said waist strap in an opposing direction to said first closure strap, and wherein said first closure strap is removably connectable to said second closure strap around the child carrier in said closed position.

19. The child carrier of claim 18, wherein said at least one pair of closure straps is two pairs of closure straps, and wherein each of said two pairs of closure straps is positioned on an opposing side of said seat portion.

20. The child carrier of claim 16, further comprising a hood connected to said upper end.
